(19) United States
(12) Patent Application Publication
(10) Pub. No.: US 2026/0250856 A1
(43) Pub. Date: Aug. 27, 2026

(54) Rotational Electrolysis Arrangement

(71) Applicant: Stig-Erik Se-Young KARLSSON, Kållered (SE)

(72) Inventor: Stig-Erik Se-Young KARLSSON, Kållered (SE)

(21) Appl. No.: 19/162,550

(22) PCT Filed: Mar. 4, 2024
(86) PCT No.: PCT/EP2024/055563

§ 371 Date: Sep. 5, 2025

(30) Foreign Application Priority Data
Mar. 6, 2023 (EP) 23160102.2

(51) Int. Cl. C25B 9/17; C25B 9/015; C25B 9/63; C25B 11/02; C25B 15/08

(52) U.S. Cl. CPC C25B 9/17; C25B 9/015; C25B 9/63; C25B 11/02; C25B 15/08

(57) ABSTRACT

The present disclosure relates to an electrode for use as an anode or cathode for electrolysis of a liquid flowing along a flow direction. An electrolysis arrangement includes at least one such electrode and a method for performing electrolysis using the electrolysis arrangement. The electrolysis arrangement includes a cylindrical housing and a plurality of elongated electrodes each extending along a longitudinal direction parallel to the central axis. The plurality of electrodes is arranged in a concentric pattern around the central axis inside the cylindrical housing. The electrolysis arrangement also includes fluid actuating means for causing a rotational flow of a fluid around said central axis inside said inner volume of said cylindrical housing.

### TECHNICAL FIELD OF THE INVENTION

The present invention relates to an electrolysis electrode for use as an anode or cathode for production of electrolysis products, an electrolysis arrangement comprising the electrode and a method for performing electrolysis using the electrolysis arrangement.

### BACKGROUND OF THE INVENTION

Molecular hydrogen, also referred to as hydrogen gas, (H₂) can be used as a multipurpose fuel in a large variety of applications. For example, molecular hydrogen can react with molecular oxygen, also referred to as oxygen gas, (O₂), which is abundant in the air, in an exothermic reaction that produces water (H2O) as the only residual product. Accordingly, molecular hydrogen is sometimes preferred to carbon based fuels, such as diesel or gasoline, as the residual products does not introduce carbon dioxide (CO₂) into the atmosphere. In addition, molecular hydrogen can be compressed and cooled, even to the point of liquification, allowing molecular hydrogen to be stored at great energy-to-volume densities, making molecular hydrogen a suitable fuel for e.g. propelling space rockets.

Molecular hydrogen can also be used in combustion engines to power land, sea or airborne vehicles or to power generators for production of electricity. Molecular hydrogen is also widely used in different chemical and manufacturing processes, such as in petrochemical industries (e.g. for hydrogenolysis) and in the semiconductor industry. Moreover, molecular hydrogen is also used as a coolant as it features many preferable coolant properties, such as high thermal conductivity.

One method for producing molecular hydrogen is via electrolysis of water, wherein two electrodes are placed in a water bath and connected to a voltage source which produces a potential difference of typically a few volts between the submerged electrodes. A reduction reaction will occur at the cathode where electrons are donated to hydrogen cations (H+) forming molecular hydrogen (hydrogen gas) and an oxidation reaction will occur at the anode where electrons are donated from oxygen anions (O−) to the anode producing molecular oxygen (oxygen gas). The two gases will rise out of the water and can be collected and stored, to be subsequently used.

A drawback with conventional electrolysis is that while efficiency and production rate of the process in theory is quite high, the obtainable efficiency and production rate is in practice is much lower, due to e.g. formation of bubbles on the anode and cathode. A bubble forming on the anode or cathode effectively deactivates a portion of the anode and cathode as this portion can temporarily not be used for electrolysis until the bubble is dispersed.

To overcome this problem, rotating disc electrolysis is proposed in international patent application with application number PCT/US2022/015277 wherein an anode disk is placed next to a cathode disk, and a separation layer is placed between the anode and cathode disc. When the disks rotate in a vessel filed with water, the electrolysis process will occur between the disks and centrifugal forces will rapidly remove any bubbles while also providing means for separating the electrolysis gas products from the water electrolyte.

A drawback with this solution is e.g. that the discs must be placed rather far apart, which degrades efficiency, to give room for the separation layer and enable water to enter the space between the discs.

### SUMMARY OF THE INVENTION

In view of the drawbacks of existing solutions there is a need for an improved electrode and electrolysis arrangement for performing electrolysis that overcomes the drawbacks of existing solutions and enhances efficiency. It is a purpose of the present invention to provide an improved electrode, electrolysis arrangement and method for performing electrolysis.

According to a first aspect of the invention there is provided an electrolysis arrangement comprising a cylindrical housing, extending along a central axis, the cylindrical housing defining an inner volume inside said cylindrical housing. The arrangement further comprises a plurality of elongated electrodes, each extending along a longitudinal direction parallel to the central axis, and the plurality of electrodes being arranged in a concentric pattern around the central axis inside the inner volume, each electrode being separated from a neighboring electrode with a gap. The arrangement further comprising fluid actuating means for causing a rotational flow of a fluid around said central axis (defining a flow direction) inside said inner volume of said cylindrical housing.

The fluid may be a liquid such as water. In some embodiments the liquid is water mixed with a suitable electrolyte such as a salt, acid or base. For instance, the liquid is seawater or fresh water that that are known to comprise electrolyte. The electrodes may also be configured to be connected to a voltage source for controlling a voltage between neighboring electrodes to cause electrolysis of the fluid between the electrodes.

The present invention is at least partially based on the understanding that with this arrangement, fluid will be forced between the gap between electrodes due to centrifugal forces, and since the gap can be made very narrow, the electrolysis process becomes very efficient. Additionally, the centrifugal operation allows the electrolysis products to be separated into a radial distribution around the central axis.

In some implementations, the electrodes are wing-shaped and arranged to provide lower fluid resistance in the rotational fluid flow.

With an electrode that is wing shaped, the fluid will flow around the electrode without causing turbulence which means that the fluid remains close to the electrode which facilitates efficient electrolysis. In addition, a wing shaped electrode causes less turbulence in the fluid flow meaning that less energy is required to maintain the fluid flow. Another benefit is that bubbles formed by electrolysis products are quickly swept away from the wing shaped electrodes meaning that the impeding effects caused by bubble formation is mitigated.

In some implementation, each electrode has a width in a width direction and a height in a height direction. Wherein the width direction extends parallel with the flow direction and the height direction is perpendicular to the flow direction and the longitudinal direction, and wherein the width is greater than the height. With electrodes that extend longer in the width direction than in the thickness direction the electrodes will be more aerodynamic which reduces the risk of turbulence in the fluid flow.

In some implementations, the electrodes have a first surface and a second surface arranged opposite of the first surface. The first surface and second surface meet at an acute angle at a leading edge of the electrode, wherein the leading edge defines the upstream end of the electrode. That is, the electrode is provided with a pointed tip forming the leading edge. A pointed tip reduces the risk of turbulence occurring and enables a smooth splitting of the fluid into flowing on either side of the wing shaped element. As an alternative, it is envisaged that the leading edge is rounded making the electrode similar in profile to an airplane wing. For example, the first surface and second surface are both convex surfaces. The first surface and second surface may analogously meet at an acute angle at a trailing edge of the electrode, the trailing edge being opposite to the leading edge and defines a downstream edge of the electrode.

In some implementations, the first and second surfaces are convex, and the radius of curvature of the second surface is larger compared to the radius of curvature of the convex first surface. That is, the first surface is more obstructive to the fluid as the change in curvature is more rapid. When the electrode is used in a rotating flow subject to centrifugal forces, with the second surface facing away from the center of rotation, this shape becomes beneficial as the more obstructive second convex surfaces force some fluid towards the center of rotation. As a result, more of the electrodes will be covered in fluid.

In some implementations, the electrode has a leading half portion and a trailing half portion wherein the leading half portion is arranged upstream in the flow direction from the trailing half portion. The electrode comprises a fluid transportation channel between a leading opening arranged in the first surface on the leading half portion and a trailing opening arranged in the second surface on the trailing half portion.

A fluid transportation channel will aid distributing the flowing fluid between both sides of the electrodes which facilitates even wear of the electrode and accomplishes an electrolysis process that is evenly distributed along the longitudinal extent of the electrode. Especially when arranged in a rotating flow subject to centrifugal forces, the fluid transportation channels will ensure that fluid is moved against the centrifugal forces to more completely submerge the electrodes. In some embodiments, each electrode comprises at least two fluid transportation channels, distributed along the longitudinal length of the electrode.

In some implementations, the electrodes further comprise a respective outer layer of an electrically insulating material, preferably Aluminum Oxide, Al₂O₃, covering at least a majority of an outer surface of the electrode and an outer layer of an electrically conductive material, preferably Titanium Aluminium Nitride, TiAlN, covering at least a leading edge of the electrode wherein the leading edge defines the upstream end of the electrode. With an insulating material covering essentially the whole electrode, except the leading and/or trailing edges, the electrolysis will be confined to these edges causing the electrolysis to be concentrated to a point along the electrode where the fluid moves constantly and/or experiences the least amount of turbulence.

In some implementations, the at least two electrodes are arranged at an angular separation distance less than about 1 mm, preferably less than 0.1 mm. The separation distance can be measured perpendicular to the longitudinal direction along the flow direction, for example as the distance from a trailing edge of an upstream electrode to the leading edge of a downstream electrode. With a short separation distance of less than 1 mm and preferably about 0.1 mm the efficiency of the electrolysis process is enhanced. In some implementations of the second aspect of the invention, all electrodes are arranged at the same radial distance from the central axis. That is, the electrodes form a circular pattern that is highly suitable for electrolysis of the rotating flow.

In some implementations, the cylindrical housing further comprises a first outlet channel in fluid communication with the inside of the cylindrical housing via a first inner opening and a second outlet channel in fluid communication with the inside of the housing via a second inner opening. Wherein the first inner opening is arranged radially closer to the central axis relative the second inner opening. With outlet channels arranged in this way the electrolysis products will be separated. The separation is caused by the centrifugal forces acting upon fluid and electrolysis products inside the cylindrical housing which results in lighter gaseous electrolysis products becoming distributed closer to the axis of rotation (i.e. the central axis) and heavier gaseous electrolysis products becoming distributed further away from the axis of rotation. Accordingly, by withdrawing electrolysis products at different radial distances from the central axis the electrolysis products can be separated.

In some implementations, the fluid actuating means comprises a sleeve arranged co-axially at a radial distance between the at least one electrode and the cylindrical housing, wherein the sleeve is arranged to rotate relative the cylindrical housing and the at least one electrode. Optionally, the sleeve is provided with radial apertures extending through the sleeve and the cylindrical housing is provided a fluid inlet channel in fluid communication with the outside of the cylindrical housing and a space between the cylindrical housing and the sleeve. That is, as the sleeve rotates it actuates a rotating fluid flow inside the cylindrical housing. For example, the sleeve is provided with magnetic elements and caused to rotate with the aid of one or more electromagnets integrated into the cylindrical housing or provided externally. It is understood that by controlling the electromagnets a magnetic field can be generated which causes the sleeve to rotate by interacting with the magnetic elements.

According to a second aspect of the invention, there is provided an electrode for use as an anode or cathode for electrolysis of a liquid flowing along a flow direction, the fluid comprises an electrolyte and the electrode has a length extending in a longitudinal direction. Wherein, when the electrode is in use, it is arranged in the fluid flow such that the longitudinal direction is substantially perpendicular to the flow direction and a cross-section of the electrode in a plane perpendicular to the longitudinal direction is wing shaped, wherein, when the electrode is in use, it is arranged upstream or downstream of another wing shaped electrode extending in a longitudinal direction parallel to the longitudinal direction of the electrode. The wing-shaped electrode may be provided separately from the fluid electrolysis arrangement, e.g. as a replacement part.

According to a third aspect of the invention there is provided a method for performing electrolysis using an electrolysis arrangement according the first aspect of the invention. The method comprises the steps of injecting a fluid into the cylindrical housing, actuating the fluid with the fluid actuating means to cause a rotational flow of fluid inside the cylindrical housing, providing the at least two electrodes with an electric voltage to cause electrolysis of the fluid into electrolysis products, and extracting the electrolysis products from the inside of the cylindrical housing.

In some implementations, the method of the third aspect of the invention further comprises detecting a conductivity of the fluid injected into the cylindrical housing and controlling, based on the detected conductivity, an injection rate of a second fluid, the second fluid having a different electrolyte concentration compared to the fluid. Accordingly, the conductivity of the fluid (which is related to the concentration of electrolytes) can be controlled to enable efficient electrolysis.

The invention according to the third aspect features the same or equivalent benefits as the invention according to the first or second aspect. Any functions described in relation to the method, may have corresponding features in an electrode or electrolysis arrangement, and vice versa.

### BRIEF DESCRIPTION OF THE DRAWINGS

These and other aspects of the invention will now be described in more detail, with reference to the appended drawings showing exemplary embodiments of the present invention, wherein:

FIG. 1 is an exploded view of an electrolysis arrangement according to some implementations.

FIG. 2 depicts a plurality of wing shaped electrodes arranged in a circular pattern, suitable for electrolysis of a rotating flow.

FIG. 3 is a close-up view of a plurality of wing shaped electrodes arranged in a circular pattern.

FIG. 4a is a perspective view of a wing shaped electrode with a plurality of fluid transportation channels.

FIG. 4b is a cross-sectional view of a wing shaped electrode showing the fluid transportation channel as well as the width and height extension of the electrode.

FIG. 5 is a cross-sectional view of two neighboring wing shaped electrodes arranged in a fluid flow.

FIG. 6 depicts a wing shaped electrode coated with an electrically insulating material covering a majority of the outer surface of the electrode.

FIG. 7 is a perspective view of an inlet sealing plate used to seal the cylindrical housing and inject fluid according to some implementations.

FIG. 8 is a perspective view of an outlet sealing plate used to seal the cylindrical housing and extract electrolysis products from the inside of the cylindrical housing according to some implementations.

FIG. 9 is an exploded view showing how the fluid inlet plate is attached to the cylindrical housing and optionally used with a fluid spreading plate.

FIG. 10 is a flowchart describing a method for using the electrolysis arrangement to achieve electrolysis of a fluid according to some implementations.

### DETAILED DESCRIPTION OF CURRENTLY PREFERRED EMBODIMENTS

In the following detailed description, preferred embodiments of the invention will be described. However, it is to be understood that features of the different embodiments are exchangeable between the embodiments and may be combined in different ways, unless anything else is specifically indicated. It may also be noted that, for the sake of clarity, the dimensions of certain components illustrated in the drawings may differ from the corresponding dimensions in real-life implementations of the invention.

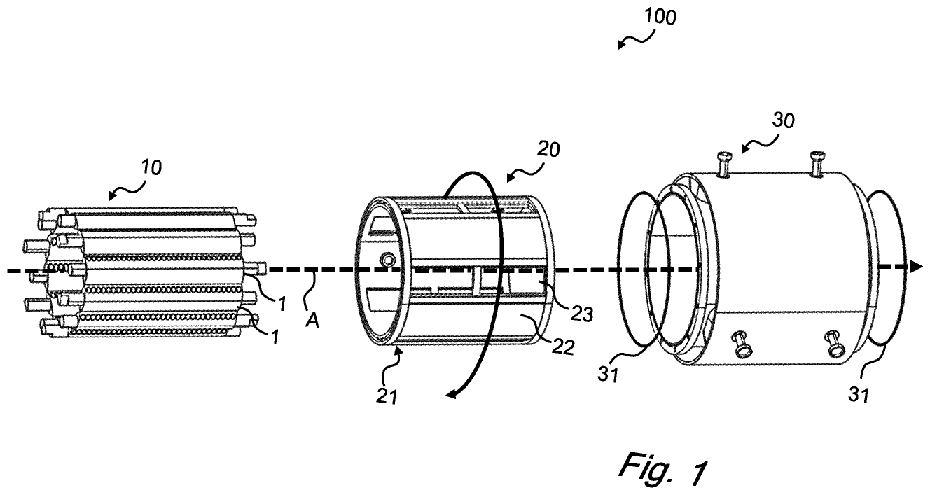

FIG. 1 shows an exploded view of an arrangement 100 for performing electrolysis. The arrangement 100 comprises a plurality of wing shaped elongated electrodes 1 arranged in a concentric pattern around the central axis A forming a cylindrical electrode set 10. In other words, the electrodes 1 are arranged concentrically, similar to the concentric arrangement of staves of a barrel, with the difference being that electrodes 1 are straight in the longitudinal length direction and not curved as often is the case for barrels. Each electrode 1 in the cylindrical set 10 extends along a respective longitudinal length axis that is parallel to, but displaced from, the central axis A forming this cylindrical revolving pattern. Additionally, while each electrode 1 is preferably arranged very close to a neighboring electrode 1 (e.g. so as to form a gap less than 1 mm) all electrodes are separated from each other in the tangential direction around the central axis A. In some implementations all electrodes are arranged at a substantially same radial distance RI from the central axis A.

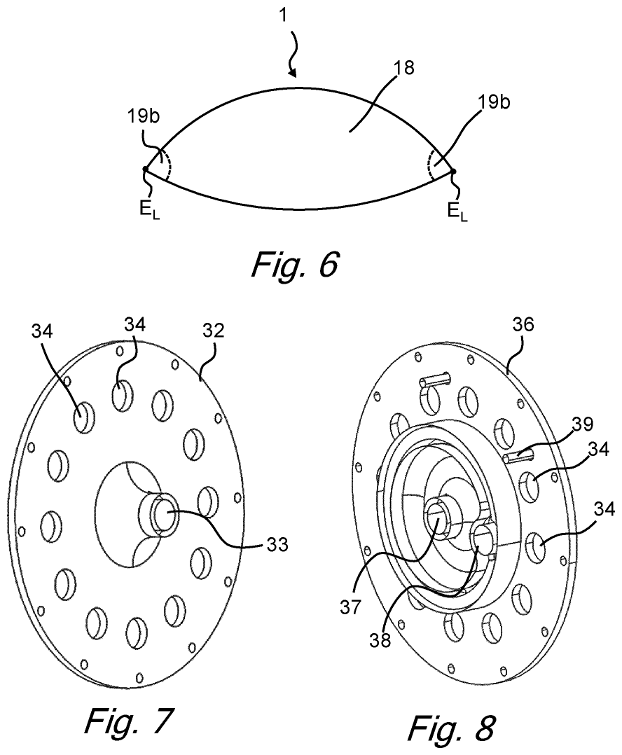

To confine a rotating fluid, the electrolysis arrangement 100 further comprises a cylindrical housing 30 that surrounds the cylindrical set of electrodes 10 in the radial direction. The cylindrical housing 30 is preferably rigid, and e.g. made of metal, preferably a non-magnetic metal. In some implementations, the cylindrical housing is coated or made of an electrically insulating material such as plastic or aluminum oxide, Al₂O₃. The cylindrical housing 30 defines an interior space configured to contain the fluid and the electrodes 1. The housing 30 is substantially cylindrical, having two, substantially circular, sides. To completely seal the housing 30, the housing 30 may further comprise an inlet sealing plate and outlet sealing plate that are attached to the respective circular sides of the housing 30. To facilitate a fluid tight seal between the sealing plates a sealing ring 31 (often referred to as an O-ring) made of a compressible material may be arranged between the cylindrical housing 30 and each sealing plates. The sealing inlet plate and sealing outlet plate will be described in further detail in connection to FIG. 6 and FIG. 7 below. The cylindrical housing 30 could be realized with varying dimensions, e.g. an inner radius of the cylindrical housing could be between 30 and 80 mm, such as about 50 mm.

The electrolysis arrangement 100 further comprises fluid actuating means 20 configured to actuate the rotating fluid flow inside the cylindrical housing 30. In the embodiment shown in FIG. 1, the fluid actuating means 20 is in the form of a sleeve 21 provided with at least one radial opening 23. The sleeve 21 is substantially cylindrical and configured to be arranged co-axially between the electrodes 1 and the cylindrical housing 30. The sleeve 21 is further configured to be rotatable with respect to the electrodes 1 and the cylindrical housing 30. As the sleeve 21 rotates, the fluid inside the cylindrical housing 30 will also start to rotate relative the electrodes 1 and the cylindrical housing 30, which achieves the rotational fluid flow around the central axis A.

The cylindrical electrode set 10 is configured to be placed in a fluid, such as water with an electrolyte, that flows along a flow direction substantially perpendicular to the longitudinal axis of the electrodes 1. With the electrodes 1 arranged as a cylindrical set 10 a fluid flow that rotates around the central axis A is one example of fluid flow that is substantially perpendicular to the longitudinal length direction axis of the electrodes 1. This type of fluid flow can be achieved by the cylindrical housing 30 and the fluid actuating means 20.

In some implementations, the sleeve 21 is provided with one or more magnetic elements 22 that comprise a magnetic material, such as neodymium (e.g. NdFeB) or ferrite. By arranging one or more electromagnets (not shown), such as electric coils, in the electrolysis arrangement 100 and controlling a current flowing through the electromagnets it is possible to rotate the sleeve 21 without having a direct mechanical contact with the sleeve 21. For example, the electromagnets may be integrated in the cylindrical housing 30 so as to be very close to the magnetic elements 22 in the sleeve 21, which facilitates a strong coupling between the magnetic elements 22 and the electromagnets. Alternatively, the electromagnets are arranged externally and the housing 30 is made of a material permeable to electromagnetic fields. Thus, the sleeve 21 can be configured to be rotated by exerting an electromagnetic force on the sleeve 21.

As an alternative to the rotating sleeve 21, it is envisaged that other types of fluid actuating means 20 could be used to generate the rotational fluid flow. For example, a propeller or impeller can be arranged inside the cylindrical housing 30 to generate the rotational flow of fluid. However, it is beneficial if the fluid actuating means 20 are driven with electromagnetic forces as this enables the fluid actuating means 20 to be driven without direct mechanical contact with e.g. a driveshaft entering into the interior of the cylindrical housing 30. A driveshaft rotating relative to the cylindrical housing is difficult to hermetically seal to ensure that the fluid or gaseous electrolysis products do not leak out of the housing 30. With electromagnetically operated fluid actuating means 20 direct mechanical contact with a drive unit provided outside of the cylindrical housing 30 can be avoided, meaning that it possible to achieve an electrolysis arrangement 100 without any moving or rotating parts entering the interior of the cylindrical housing 30.

As another example, the fluid can be injected inside the cylindrical housing 30 with a high velocity (e.g. from a turbo-pump) in a direction substantially perpendicular to the central axis A and at some radial distance from the central axis A whereby the high velocity injection realizes a rotational fluid flow inside the housing.

Many rotational rates of the fluid are possible, for example the fluid actuating means 20 is operated to achieve a fluid rotation rate of between 2000 RPM and 4000 RPM, such as about 3000 RPM. In general, lower rotational rates can be used when the inner diameter of the cylindrical housing 30 is larger, since the fluid velocity at the inner periphery of the cylindrical housing 30 will increase at a given rotational rate, for larger inner diameters and vice versa.

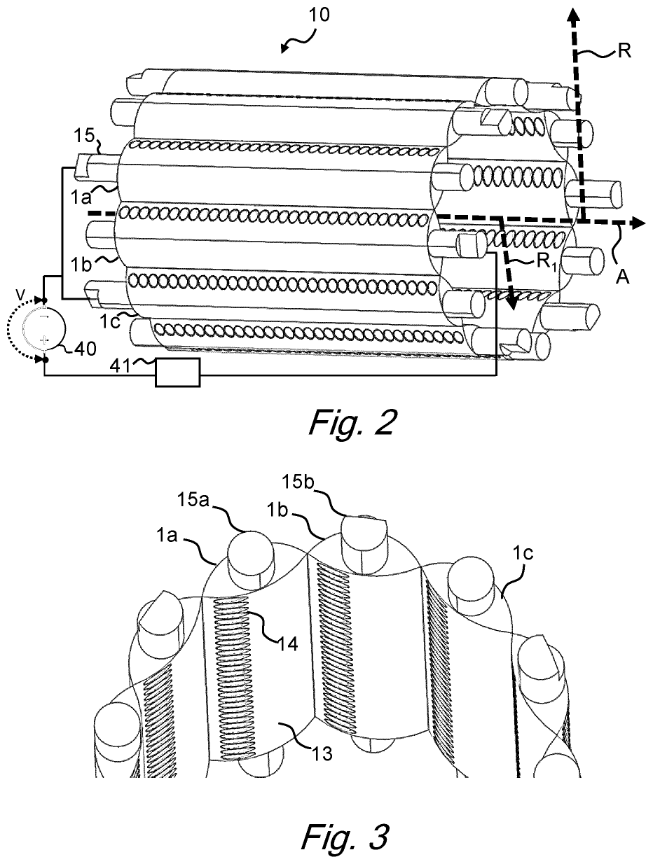

FIG. 2 depicts a set of cylindrically arranged electrodes 10 comprising a plurality of individual wing shaped electrodes 1a, 1b, 1c. In the embodiment shown in FIG. 2, all wing shaped electrodes la, 1b, 1c are arranged at substantially the same radial distance RI from the central axis A. This leaves a void space in the center of the cylindrically arranged electrode set 10 which facilitates separation of electrolyte products as will be described in the below.

Each electrode 1a, 1b, 1c is configured to be connected to a voltage source 40 in such a way that every second electrode 1a, 1c (counting clockwise or counter-clockwise around the central axis A) is provided with a first electric potential and every other electrode 1b is provided with a second electric potential, different from the first electric potential. That is, there is an electric potential difference (a voltage) V between two neighboring electrodes. For example, the voltage is 1.5 volt or 2 volts. The electric voltage V drives a current through the fluid flowing between the electrodes 1a, 1b, 1c which causes electrolysis. As an example, the voltage V between neighboring electrodes is at least 1.23 volts for electrolysis of water, such as between 1.3 and 4 volts. For electrolysis of other fluids, different voltages may be used. Assuming that the internal resistance in the electrodes and any conductors connecting the electrodes to the voltage source 40 is negligible a voltage drop of V will occur over the gap between neighboring electrodes 1a, 1b, where the electrolysis occurs. If there is no fluid between two neighboring electrodes 1a, 1b an open circuit is formed with a voltage V between the neighboring electrodes 1a, 1b. When a fluid is present between the neighboring electrodes 1a, 1b is present the circuit is closed and an electric current flows from the positive terminal of the voltage source 40 to the negative terminal via the gap between the neighboring electrodes 1a, 1b.

For example, and as shown in FIG. 2, providing neighboring electrodes 1a, 1b with voltage V may comprise connecting neighboring electrodes 1a, 1b to different terminals of a single voltage source 40. One electrode la can be connected to the positive terminal on the voltage source 40 and the neighboring electrode 1b is connected to the negative terminal on the voltage source 40, as indicated in FIG. 2.

To facilitate this type of electrical connection of the electrodes 1a, 1b, 1c to a voltage source 40 every second electrode 1a, 1c may be provided with a contacting portion 15 which extends outwardly along the longitudinal length extension of the electrode 1a, 1c while every other electrode 1b is provided with a contacting portion 15 which extends outwardly along the longitudinal length extension of the electrode 1b in the opposite direction. The contacting portions may e.g. be configured to extend out of the cylindrical housing and through the input and output sealing plates. In this way, it is possible to electrically contact the electrodes 1a, 1b, 1c from the outside of the electrolysis arrangement to supply the electrodes 1a, 1b, 1c with pairwise non-zero voltage V.

In some implementations, a common voltage source 40 is connected with its positive terminal to every second electrode 1a, 1c and its negative terminal to every other electrode 1b to create the electric voltage V needed for driving a current through the fluid which causes electrolysis. In some implementations, the voltage sustained by the voltage source 40 is periodically inverted, for instance this may involve that the polarity of the terminals changes over time. For example, the periodical polarity inversion is in the form square wave meaning that a first electrode la of a pair will act as both anode and cathode over time. Suitable switching frequencies for the square wave is between 0.1 Hz and 100 Hz, preferably between 0.1 Hz and 10 Hz, most preferably between 0.1 Hz and 1 Hz. By switching the polarity and allowing each electrode 1a, 1b, 1c to act as both anode and cathode, the wear of the electrodes 1a, 1b, 1c becomes more uniform, meaning that maintenance needs to be performed less often.

The voltage source 40 may be configured to maintain a fixed voltage (which optionally is periodically inverted) between neighboring electrodes 1a, 1b, 1c to cause electrolysis. In general, however, the electrical current flowing through the fluid between each pair of electrodes 1a, 1b, 1c may vary over time and/or from pair-to-pair of electrodes 1a, 1b, 1c. For instance, a varying conductivity of the fluid will impact the electrical current even if the voltage is kept constant.

When a fluid is rotated around the central axis A it will be forced towards the periphery of the housing surrounding the cylindrically arranged electrode set 10 due to centrifugal forces. Depending on the amount of rotating fluid inside the housing the electrodes 1a, 1b, 1c will be partially or completely submerged in the fluid. When the fluid undergoes electrolysis caused by the electrically excited electrodes 1a, 1b, 1c the gaseous electrolysis products will, also due to centrifugal forces, meander towards the central axis A and distribute themselves in a radially layered structure, with lighter gases closer to the central axis A and heavier gases further away from the central axis A. In implementations where the electrodes 1a, 1b, 1c are used to perform electrolysis of water into hydrogen gas and oxygen gas, the lighter hydrogen gas will move towards the central axis A whereas the oxygen gas will stabilize as a layer surrounding the hydrogen gas at a greater radial distance from the central axis A. The rotating fluid will remain at an even greater radial distance from the central axis A, in close proximity to the inner periphery of the cylindrical housing and the electrodes.

This distribution of the electrolysis products and fluid brings many benefits. Firstly, the electrolysis products can be separated easily by choosing at what radial distance the gases formed inside the electrolysis arrangement are extracted. The arrangement of the electrodes 1a, 1b, 1c at substantially the same predetermined radial distance RI means that there are no obstructing elements in the center of the cylindrical housing that otherwise could prohibit extraction of the gases. Secondly, the centrifugal forces ensures that the fluid is kept in close proximity to the electrodes 1a, 1b, 1c at all times meaning that the electrodes 1a, 1b, 1c are at least partially submerged in fluid such that electrolysis can occur continuously. Thirdly, as the fluid moves constantly around the electrodes 1a, 1b, 1c any gas bubbles with electrolyte products that form between the electrodes is rapidly dispersed such that they do not impede the electrolysis process.

It is also noted that while the cylindrically arranged electrode set 10 shown in FIG. 2 has twelve individual electrodes 1a, 1b, 1c it is envisaged that fewer or more electrodes 1a, 1b, 1c could be used in the same fashion. Preferably, the number of electrodes 1a, 1b, 1c is an even number such that when every second electrode 1a, 1c can be provided with the first electric potential and every remaining electrode 1b can provided with the second electric potential (e.g. by being connected to the same voltage source 40) such that any pair of neighboring electrodes 1a, 1b exhibits an electric voltage V which causes electrolysis and drives a current between the neighboring electrodes.

In some implementations, a current or resistance sensor 41 is connected to at least two neighboring electrodes 1a, 1b. The current or resistance sensor 41 is configured to measure the current flowing between the neighboring electrodes 1a, 1b and/or a resistance between the neighboring electrodes 1a, 1b. Based on the measured current and/or resistance it possible to determine the amount of fluid, and optionally the conductivity of the fluid, present in the cylindrical housing. For example, if the fluid level is low a reduced amount of fluid will flow between the electrodes 1a, 1b meaning that the current is low and/or the resistance is high. On the other hand if the fluid level is high the electrodes 1a, 1b may be completely submerged in fluid meaning that the current is high and/or the resistance is low. Accordingly, the measurements performed by the current or resistance sensor can be used to control whether more fluid should be added to the inside of the cylindrical housing. For instance, if the measured resistance exceeds a threshold resistance and/or the measured current is below a current threshold more fluid is added to the inside of the cylindrical housing.

It is also envisaged that the current or resistance sensor 41 may be connected to terminals inside the cylindrical housing that are separate from the electrodes 1a, 1b and measure a current and/or resistance between the terminals. The measurements performed by the current and/or resistance sensor may be performed continuously or repeated regularly.

FIG. 3 shows a perspective close-up view of a plurality of electrodes 1a, 1b placed alongside each other in a cylindrical arrangement. Each electrode 1a, 1b, 1c has a first surface and an opposite second surface 13. When in use in a rotating fluid, the first surface faces away from the central axis A, also being the rotation axis, and the second surface 13 faces the central axis A. As seen, each electrode 1a, 1b, 1c may comprise at least one fluid transportation channel configured to allow fluid to pass through the electrode 1a, 1b, 1c. An outlet opening 14 of the fluid transportation channel is arranged in the second surface 13 and an inlet opening (not shown) is arranged in the first surface. In this way, when the fluid rotates in a counter-clockwise direction in FIG. 3, fluid on the outside of the electrodes (i.e. at a radial distance greater than the electrodes) will be forced though the at least one fluid transportation channel to the other side of the electrodes 1a, 1b, 1c. Due to centrifugal forces, the fluid will then be forced back to the outside of the electrodes 1a, 1b, 1c via the small separation distance separating the electrodes la, 1b, 1c where electrolysis occurs.

FIG. 3 also shows contacting portions 15a, 15b of two neighboring electrodes la, 1b. As seen, the contacting portion 15b of the second electrode 1b extends further along the longitudinal direction. The contacting portion 15a of the first electrode 1a does not extends as far and may be mounted to a groove in one of the sealing plates. The contacting portion 15b of the second electrode 1b on the other hand, extends further and may pass through the sealing plate to allow it to be electrically contacted (e.g. connected to a first terminal of a voltage source). The situation is reversed at the other sealing plate, wherein the contacting portion 15a of the first electrode la extends through the other sealing plate to allow it to be electrically contacted (e.g. connected to a second terminal of the voltage source).

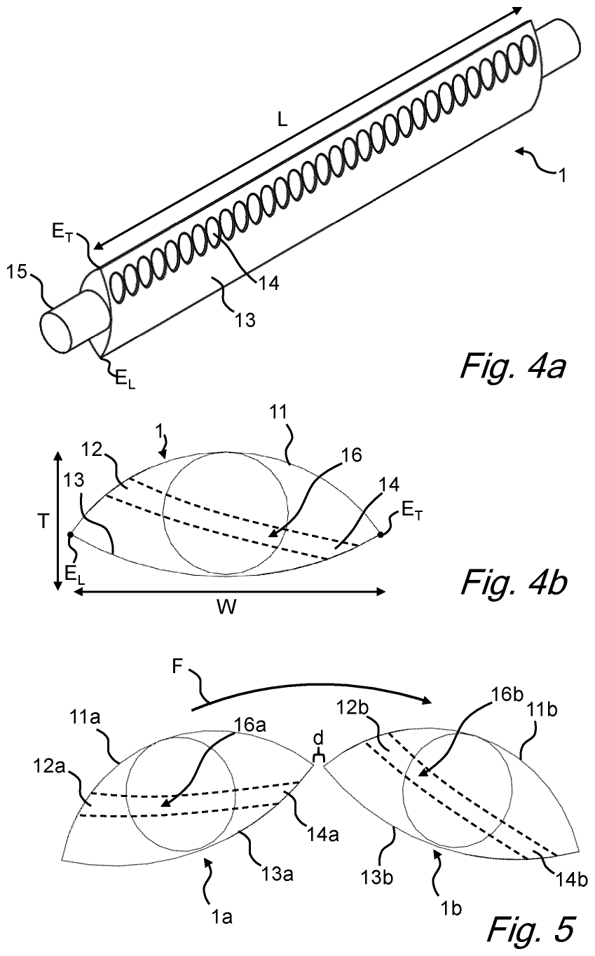

FIG. 4a is a perspective view of a single wing shaped electrode 1 according to some implementations. The electrode 1 may be provided separately, for example as a replacement part, for subsequent installation in an electrolysis arrangement or the electrode 1 is integrated into an electrolysis arrangement. The electrode 1 is elongated and extends along a longitudinal direction L. The electrode may be of varying longitudinal lengths while still providing the same operation. As an example, the electrode 1 has a longitudinal length of between 50 mm and 200 cm, such as 110 mm excluding the contacting portions optionally provided on either side of the electrode 1. The electrode 1 comprises a plurality of fluid transportation channels of which the outlet opening 14 is visible in FIG. 4a. It is envisaged that each electrode 1 may comprise only one fluid transportation channel or a plurality of such channels, distributed at intervals along the longitudinal length of the electrode 1.

With further reference to FIG. 4b, showing a cross-sectional view of an electrode 1, the electrode 1 also has a width W, indicating the extent of the electrode 1 substantially parallel with the flow direction, and a thickness T, indicating the extent of the electrode 1 in a direction substantially perpendicular to the flow direction and the longitudinal length direction L. Preferably, the width W is greater than the thickness T making the wing shaped electrode 1 more aerodynamic. For example, the width W is between 15 mm and 25 mm, such as about 20 mm, and the thickness T is between 5 and 10 mm, such as about 8 mm.

As described in the above, the electrode 1 has a first surface 11 and a second surface 13, opposite the first surface 11. In some implementations, one or both of the first and second surface 11, 13 are convex surfaces. Optionally, a radius of curvature of the first surface 11 is smaller compared to a radius of curvature of the second surface 13. When the electrode 1 is arranged in a rotating fluid flow, the first surface 11 faces away from the axis of rotation whereas the second surface 13 faces the axis of rotation. This arrangement of the electrode 1, especially in combination with both surfaces 11, 13 being convex has proven to provide well suited fluid flow around the electrodes 1 which provides efficient electrolysis.

The wing shaped electrode 1 has a leading edge EL and a trailing edge ET wherein the electrode 1 is configured to be placed in a fluid flow with the leading edge EL arranged upstream of the trailing edge ET. In some implementations, the first and second surface 11, 13 meet at the leading edge EL forming a rounded or pointed edge. For example, the first and second surface 11, 13 meet at an acute angle forming the leading edge EL. Similarly, it is envisaged that the first and second surface 11, 13 meet at an acute angle forming the trailing edge ET.

FIG. 4b also shows that the electrode 1 may comprise a fluid transportation channel 16 connecting an inlet opening 12 with an outlet opening 14. The inlet opening is arranged in the first surface 11 of a leading half-portion of the electrode 1 and the outlet opening is arranged in the second surface 13 of a trailing half-portion of the electrode 1. The leading and trailing half-portions are defined by dividing the electrode 1 into two half-portions using a plane spanned by the thickness T and longitudinal L directions. One half-portion comprises the leading edge EL and is arranged upstream when the electrode 1 is placed in the fluid flow, this half-portion is the leading half-portion. The other half portion comprises the trailing edge ET and is arranged downstream of the leading half-portion when the electrode is placed in a fluid flow, this half portion is called the trailing half-portion.

With reference to FIG. 5, a cross-sectional view of two neighboring electrodes 1a, 1b is show when the electrodes 1a, 1b are arranged in a rotational flow. The fluid flow direction is indicated schematically with the arrow F. As described in the above the respective first sides 11a, 11b of the electrodes 1a, 1b are arranged facing away from the center of rotation whereas the respective second surfaces 13a, 13b are arranged closer to, and facing, the center of rotation. The electrodes 1a, 1b are maintained at a voltage (e.g. with the aid of a voltage source) such that there is an electric voltage between neighboring electrodes 1a, 1b that causes electrolysis to occur mainly in the gap d between trailing edge of the upstream electrode 1a and the leading edge of the downstream electrode 1b. The tangential extent of each electrode 1a, 1b is much greater than the gap d, such as at least five times greater or ten times greater.

As the rotational flow of fluid is subject to centrifugal forces the fluid will be forced towards the first sides 11a, 11b of the electrodes 1a, 1b when the electrodes are placed in the cylindrical housing. However, with the fluid transportation channels 16a, 16b the fluid will also be brought to the second surface 13a, 13b of the electrodes 1a, 1b and forced between the gap d. In operation, the rotating fluid following the flow direction F will first reach the leading edge of the first electrode la. Some fluid may flow along the second surface 13a of the first electrode la, some fluid will flow long the first surface 11a of the first electrode la and some fluid will enter the fluid transportation channel 16a via inlet opening 12a. The fluid flowing along the inner second surface 13a and coming out of the fluid transportation channel 16a at the outlet opening 14a will be forced by centrifugal forces through the narrow gap d where electrolysis occurs splitting the fluid into gaseous electrolysis products that are rapidly removed from the gap d by the centrifugal forces and continuous flow of fluid around the electrodes 1a, 1b.

The fluid will then flow along the first side 11b of the second electrode 1b and enter the inlet opening 12b of the second electrode 1b. The fluid entering the inlet opening 12b of the second electrode will flow through the fluid transportation channel 16b and exit via the fluid outlet opening 14b. The fluid will then flow through a gap between the second electrode 1b and a downstream third electrode (not shown) in a manner analogous to the flow of fluid through the gap between the first and second electrodes 1a, 1b. Accordingly, when a plurality of electrodes 1a, 1b are arranged in a circular arrangement inside a rotating flow F, the rotating fluid will flow around the electrodes 1a, 1b in such a manner so as to be repeatedly forced through the gaps d where electrolysis occurs. The gap d can be made very short, such as less than 1 cm, preferably less than 1 mm or most preferably less than 0.5 mm, such as about 01 mm, allowing the electrolysis process to be very efficient. Accordingly, in some implementations, the greatest separation between a trailing edge of an upstream electrode la and the leading edge of a downstream electrode 1b is equal to the gap d. Optionally, both the leading edge and the trailing edge are formed by respective electrode sides 11a, 13a, 11b, 13b meeting to form acute angles.

In some implementations, each electrode 1 is made of an electrically conducting material such as steel. In FIG. 6 it is shown that each electrode may also be coated with a layer of an electrically insulating material 18, such as aluminum oxide, Al₂O₃. The electrically insulating material 18 may cover a majority, but not all, of the outer surface of each electrode 1. Specifically, the electrically insulating material 18 covers the outer layer of the entire electrode except for a region 19a, 19b around the leading edge EL and trailing edge ET respectively. The region 19a, 19b around the leading edge EL and trailing edge ET respectively instead features no coating (i.e. exposing the conductive material of the electrode) or an electrically conductive coating such as titanium aluminum nitride, TiAlN. A conductive coating such as TiAlN in the regions of the leading edge EL and trailing edge ET serves to protect the edges and decrease wear of the electrode 1, meaning that maintenance of electrode 1 can occur less often. Additionally, a TiAlN coating can be made very smooth, with a low surface roughness which further facilitates even spread of the current distribution between neighboring electrodes.

Additionally, by covering the majority of the electrode 1, excluding the regions 19a, 19b around the leading and trailing edges EL, ET that play an active role in the electrolysis, the efficiency of the electrolysis process is enhanced since the electrical current becomes concentrated to the gap between neighboring electrodes 1.

Applying the insulating material 18 to the electrode 1 can be performed in many different ways. Some insulating materials can e.g. be applied as a spray coating or using sputter deposition. It is also envisaged that the insulating material 18 is provided as a powder which is placed on the electrode 1 and heated (e.g. with induction) to attach the insulating material 18 to the electrode 1. This method is particularly suitable for deposition of Al₂O₃ powder wherein temperatures of 950° C. to 1000° C. can be used to fixate Al₂O₃ to the outer surface of the electrode 1.

FIG. 7 shows a perspective view of an inlet sealing plate 32 configured to be mounted to an inlet side of the cylindrical housing shown in FIG. 1. The inlet sealing plate 32 is substantially circular and has an inlet channel 33 configured to receive the fluid (optionally mixed with a second fluid as will be described in the below). The inlet sealing plate 32 further comprises a plurality of electrode apertures 34, each configured to receive a contacting portion of an electrode to reliantly hold the electrode in place while also allowing the electrode to be placed in electric contact with an external voltage source. To make sure that no fluid or electrolyte products leaks out via the electrode apertures 34 a sealing ring of a resilient material (e.g. an O-ring) can be placed in each electrode aperture 34 to seal against the contacting portion of each electrode.

In some implementations, a conductivity sensor is arranged in the inlet channel 33 wherein the conductivity sensor is configured to measure a conductivity of the fluid. The conductive sensor may for example be connected to two electric terminals arranged in the inlet channel 33 wherein the sensor is configured to detect an electrical property indicative of the conductivity of the media (i.e. the fluid) flowing between the two electric terminals. For instance, the conductivity sensor detects at least one electrical parameter such as the resistance or conductance between the two terminal. Alternatively, the sensor measures a current that flows between the two terminals and determines the conductivity based on the measured current. The conductivity is indicative of e.g. the amount of electrolyte present in the fluid may be used to control an injection rate of a second fluid having a different electrolyte concentration compared to the fluid.

FIG. 8 shows a perspective view of an outlet sealing plate 36 which, like the inlet sealing plate, is configured to mounted to a side of the cylindrical housing. The outlet sealing plate 36 is configured to be mounted against the outlet side of the cylindrical housing shown in FIG. 1. The outlet sealing plate 36 also comprises a plurality of electrode apertures 34, each configured to receive a contacting portion of an electrode to reliantly hold the electrode in place while also allowing the electrode to be placed in electric contact with an external voltage source. In FIG. 8, an outer side of the outlet sealing plate 36 is shown and the opposite inner side of the outlet sealing plate 36 is configured to face the rotating flow of fluid and electrolysis products. The outlet sealing plate 36 comprises a first outlet channel 37 in fluid communication with the inside of the cylindrical housing. The outlet sealing plate 36 also comprises a second outlet channel 38 in fluid communication with the inside of the cylindrical housing. The first outlet channel 37 is in fluid communication with an opening positioned on the inside of the cylindrical housing that is closer to the central axis compared to the opening with which the second outlet channel 38 is in communication with.

As described in the above, the centrifugal forces acting on the rotating fluid and the electrolysis products inside the cylindrical housing will result in a distribution of gaseous electrolysis products inside the cylindrical housing with lighter gases closes to the central axis and heavier gases at a greater radial distance from the central axis. Accordingly, the gaseous electrolysis products will be separated, and the lighter gases will be extracted via the first outlet channel 37 and the heavier gases will be extracted via the second outlet channel 38. In some implementations, the fluid is water mixed with an electrolyte whereby the lighter gaseous electrolysis product is hydrogen gas H₂ and the heavier is gaseous electrolysis product is oxygen gas O₂.

Optionally, one or more third outlet channel(s) 39 are also arranged in the outlet sealing plate 36 wherein the third outlet channel(s) 39 are in fluid communication with positions inside the cylindrical housing placed at a radial distance from the central axis that is greater than both the extraction position of the first and second outlet channels 37, 38. To this end, the third outlet channel(s) can be used to extract fluid or other substances (e.g. salt, contaminations or foreign particles such as microplastics) that are heavier than the gaseous electrolysis products.

FIG. 8 illustrates how the inlet sealing plate 32 may be arranged with the cylindrical housing 30 and the fluid actuating sleeve 21. In some implementations, a fluid spreading plate 35 is arranged between the inlet sealing plate 32 and the fluid actuating sleeve 21. The fluid spreading plate 35 is smaller in diameter with respect to the cylindrical housing 30 meaning that it can fit inside the cylindrical housing 30. The fluid spreading plate 35 may be of a diameter similar to that of the fluid actuating sleeve 21 meaning that the fluid spreading plate 35 may seal one side of the fluid actuating sleeve 35 while still allowing fluid to flow around the fluid spreading plate 35 and come into contact with the electrodes inside the fluid actuating sleeve 35 via the radial openings 23 in the fluid actuating sleeve 21. In this way, injected fluid is prohibited from entering into the interior of the fluid actuating sleeve 21 along the central axis and can only enter into the interior of the fluid actuating sleeve 21 in the radial direction. This has shown to improve spreading of the fluid more evenly around the electrodes while also reducing the risk of fluid splashing and contaminating the electrolysis product distribution that emerges inside the cylindrical housing 30 when the electrolysis arrangement is in use.

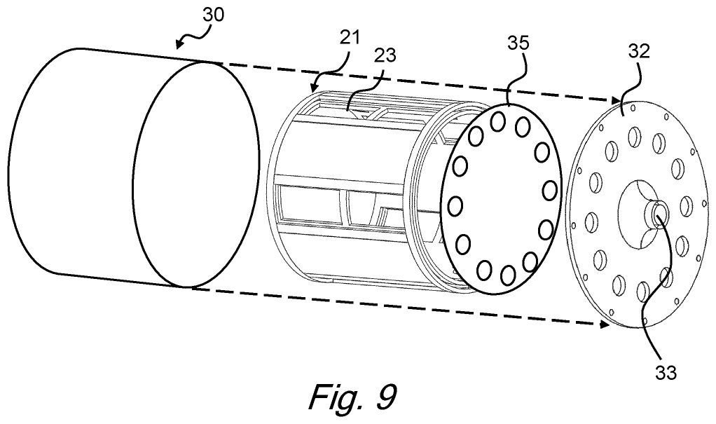

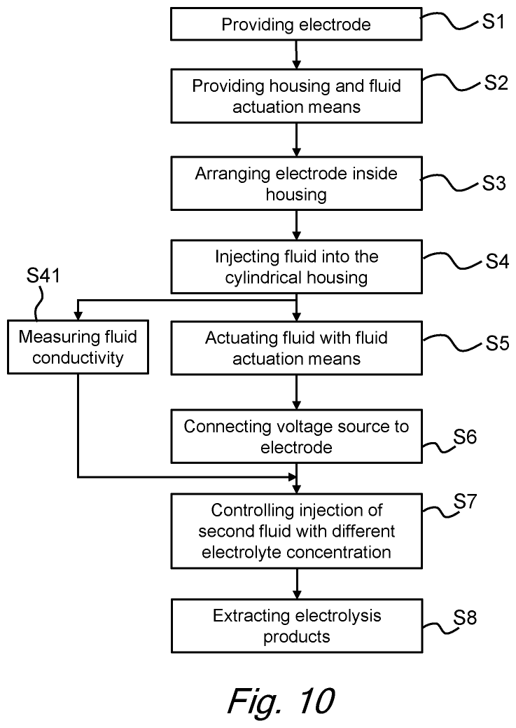

FIG. 9 is a flow-chart describing a method for operating the electrolysis arrangement 100 shown in FIG. 1. At step S1 at least two wing shaped electrodes 1 are provided and at step S2 a cylindrical housing 30 and fluid actuating means 20 are provided.

With these parts, it is possible to form an electrolysis arrangement 100 as shown in FIG. 2 and at step S3 the electrodes 1 and fluid actuating means 20 are arranged inside the cylindrical housing 30 to form the electrolysis arrangement 100. That is, steps S1-S3 may be replaced with a single step, involving providing an electrolysis arrangement 100 with two or more wing shaped electrodes 1.

At step S4 a fluid, e.g. water mixed with an electrolyte such as sodium chloride or another salt or mineral, is injected into the cylindrical housing 30. Optionally, the conductivity of the fluid is measured at step S41. The conductivity can be measured as the fluid is injected (i.e. prior to reaching the inside of the cylindrical housing) or after the fluid has been injected into the cylindrical housing 30.

At step S5 the fluid actuating means 20 are actuated to generate a rotating flow inside the interior of the cylindrical housing 30 around the wing shaped electrodes 1. It is understood that in some embodiments, e.g. when a high-pressure, directed, injection of fluid causes the rotation flow steps S4 and S5 are essentially the same step as they occur simultaneously. In some implementations, wherein the fluid actuating means is in the form a fluid actuating sleeve 21 or impeller as described in the above step S5 may involve operating the fluid actuating means 20. As an example, operating the fluid actuating means 20 may comprise generating a rotating electromagnetic field which in turn rotates the fluid actuating sleeve 21 provided with magnetic elements 23.

At step S6 a voltage source is connected to the least two electrodes 1 which drives a current in the fluid between the electrodes 1. This current causes electrolysis to occur in the rotating fluid flow inside the cylindrical housing 30. In some implementations, there are two or more electrodes 1 arranged inside the cylindrical housing at the same radial distance from the central axis. For example, step S6 may comprise connecting each electrode 1 to a voltage source (e.g. every second electrode is connected to the negative terminal and every other electrode is connected to the positive terminal of a same voltage source) such that a voltage is maintained between neighboring electrodes 1. Furthermore, step S6 may comprise supplying an alternating voltage to neighboring electrodes 1, preferably in the form a square wave, such that there is a non-zero voltage between neighboring electrodes 1 and that the polarity of the neighboring electrodes 1 is repeatedly reversed.

Optionally, the method then goes to step S7 comprising controlling the injection of a second fluid based on the measured conductivity. The second fluid is a fluid having an electrolyte concentration (e.g. a NaCl concentration) that is different from that of the (first) fluid. For example, if the conductivity is low and the second inlet fluid comprises an electrolyte concentration that is higher compared to the fluid, the second fluid can be injected resulting in an increased conductivity due to electrolyte being added to the inside of the cylindrical housing 30. In one example, the second fluid is distilled water (having effectively no electrolytes) and the fluid is seawater (having a salinity of about 3%). As the electrolysis process continues, the water will be split into electrolysis products whereby the electrolysis products are extracted. The electrolytes (e.g. NaCl) will remain inside the cylindrical housing 30 and will build up over time if more fluid is injected without any fluid being let out. However, a too high concentration of electrolytes may be beneficial to avoid meaning that fluid could be extracted from the inside of the cylindrical housing 30 and/or the second fluid could be added. Accordingly, it is possible to control the electrolyte concentration (and thereby the fluid conductivity) by controlling the injection rate of the fluid, the injection rate of the second fluid and the rate at which fluid is let out of the cylindrical housing 30 via one or more outlet channels. For instance, it is envisaged that it is not necessary to extract any fluid from the cylindrical housing 30 if seawater and is injected first, wherein distilled water is added as the second fluid to keep a suitable total fluid level inside the cylindrical housing 30. The water will continuously be converted to hydrogen gas and oxygen gas and extracted wherein the electrolyte will remain inside the cylindrical housing 30. On the other hand, if the fluid is seawater, or any other fluid having a suitable electrolyte concentration, it is envisaged that seawater can continuously be added and removed from the cylindrical housing 30.

The rotating flow inside the cylindrical housing 30 causes the electrolysis products (e.g. hydrogen and oxygen gas) to distribute themselves inside the cylindrical housing with lighter gases (hydrogen gas) radially closer to the central axis A and heavier gases (oxygen gas) radially further away from the central axis A. This enables the electrolysis products to be extracted separately at step S8. For example, the electrolysis products will exit through respective outlet channels of their own volition, due to diffusion or an over-pressure provided inside the cylindrical housing (e.g. due to the fluid injection). It is also envisaged that the electrolysis products are extracted using an external device for providing suction, such as a pump or similar. The extracted electrolysis products can subsequently be used (e.g. in a chemical process or as a fuel) or stored for later use.

The person skilled in the art realizes that the present invention by no means is limited to the preferred embodiments described above. On the contrary, many modifications and variations are possible within the scope of the appended claims. For example, while electrolysis of liquid, and especially water, has been presented as the main example in the above it is envisaged that the electrolysis arrangement can be used analogously for electrolysis of other fluids, including liquid and gases. In the claims, the word “comprising” does not exclude the presence of other elements or steps than those listed in the claim. The word “a” or “an” preceding an element does not exclude the presence of a plurality of such elements.

1-15. (canceled)

16. An electrolysis arrangement comprising:
a cylindrical housing, extending along a central axis, the cylindrical housing defining an inner volume inside said cylindrical housing;
a plurality of elongated electrodes, each extending along a longitudinal direction parallel to the central axis, and the plurality of electrodes being arranged in a concentric pattern around the central axis inside the inner volume, each electrode being separated from a neighboring electrode with a gap; and
fluid actuating means for causing a rotational flow of a fluid around said central axis inside said inner volume of said cylindrical housing.

17. The electrolysis arrangement according to claim 16, wherein a cross-section of each electrode is wing-shaped.

18. The electrolysis arrangement according to claim 16, wherein:
each electrode has a width in a width direction and a height in a height direction;
the width direction extends parallel with the flow direction and the height direction is perpendicular to the flow direction and the longitudinal direction; and
the width is greater than the height.

19. The electrolysis arrangement according to claim 16, wherein:
each electrode has a first surface and a second surface arranged opposite of the first surface;
the first surface and second surface meet at an acute angle at a leading edge of each electrode; and
the leading edge defines the upstream end of each electrode.

20. The electrolysis arrangement according to claim 19, wherein the first surface and the second surface are both convex surfaces.

21. The electrolysis arrangement according to claim 20, wherein the radius of curvature of the convex second surface is larger compared to the radius of curvature of the convex first surface.

22. The electrolysis arrangement according to claim 19, wherein:
each electrode has a leading half portion and a trailing half portion;
the leading half-portion is arranged upstream in the flow direction from the trailing half-portion; and
each electrode comprises a fluid transportation channel between a leading opening arranged in the first surface on the leading half-portion and a trailing opening arranged in the second surface on the trailing half-portion.

23. The electrolysis arrangement according to claim 16, wherein each electrode comprises an outer layer of an electrically insulating material, preferably Aluminum Oxide, Al2O3, covering at least a majority part of an outer surface of the electrode and an outer layer of an electrically conductive material, preferably Titanium Aluminium Nitride, TiAlN, covering at least a region at the leading edge of the electrode wherein the leading edge defines the upstream end of the electrode.

24. The electrolysis arrangement according to claim 16, wherein at least two electrodes of said plurality of electrodes are configured to be provided with a voltage to cause electrolysis.

25. The electrolysis arrangement according to claim 16, wherein all electrodes are arranged with a separation gap that is less than about 1 millimeter, preferably less than 0.1 millimeter, such as about 0.09 mm.

26. The electrolysis arrangement according to claim 16, wherein the cylindrical housing further comprises:
a first outlet channel in fluid communication with the inside of the cylindrical housing via a first inner opening, and
a second outlet channel in fluid communication with the inside of the housing via a second inner opening,
wherein the first inner opening is arranged at a shorter radial distance from the central axis with respect to the second inner opening.

27. The electrolysis arrangement according to claim 16, wherein:
the fluid actuating means comprises a sleeve arranged co-axially at a radial distance between the at least one electrode and the cylindrical housing; and
the sleeve is arranged to rotate relative to the cylindrical housing.

28. The electrolysis arrangement according to claim 27, wherein:
the sleeve is provided with radial apertures extending through the sleeve; and
the cylindrical housing is provided a fluid inlet channel in fluid communication with the outside of the cylindrical housing and a space between the cylindrical housing and the sleeve.

29. A method for performing electrolysis comprising the steps of:
providing an electrolysis arrangement according to claim 16;
injecting a fluid into the cylindrical housing;
actuating the fluid with the fluid actuating means to cause a rotational flow of fluid inside the cylindrical housing;
connecting a voltage source to the at least two electrodes to provide a voltage between the at least two electrodes that causes electrolysis of the fluid into electrolysis products; and
extracting the electrolysis products from the inside of the cylindrical housing.

30. An electrode for use as an anode or cathode for electrolysis of a fluid flowing along a flow direction, the fluid comprises an electrolyte and the electrode has a length extending in a longitudinal direction, wherein:
when the electrode is in use, the electrode is arranged in the fluid flow such that the longitudinal direction is substantially perpendicular to the flow direction and a cross-section of the electrode in a plane perpendicular to the longitudinal direction is wing shaped; and
when the electrode is in use, the electrode is arranged upstream or downstream of another wing shaped electrode extending in a longitudinal direction parallel to the longitudinal direction of the electrode.
